(19) United States
(12) Patent Application Publication
(10) Pub. No.: US 2004/0195510 A1
(43) Pub. Date: Oct. 7, 2004

(54) Radiation sensor with synchronous reset

(76) Inventors: William N. Carr, Montclair, NJ (US); Lijun Jiang, (US)

Correspondence Address: William N. Carr, 251 South Mountain Ave., Montclair, NJ, 07042, US

(21) Appl. No.: 10/359,312

(22) Filed: Feb. 7, 2003

(51) Int. Cl. G01J 5/00

(52) U.S. Cl. 250/338.3

(57) ABSTRACT

This invention consists of a radiation sensor with a thermal cycling and synchronous readout scheme. It is intended for use with pyro-optical materials which exhibit a phase transition that is hysteric. A preferred material is vanadium oxide which has a semiconductor-metal phase transition typically at 68 deg C. and a hysteresis of a few degrees C. depending on material processing. The temperature of the pyro-optical film is cycled in synchronization with readout electronics to achieve a reset reference for the readout once each repetitive cycle. When the thermal cycle is divided into two regions, a reference and a biased frame are obtained. The readout electronics compare the reference frame the biased frame to obtain a desired difference which is an unbiased frame.

### TECHNICAL FIELD OF THE INVENTION

This invention relates generally to thermal imaging systems with sensitivity to a low level incident radiation beam typically imaged onto a plane of microplatforms formed using the technology generally referred to as microelectromechanical systems MEMS, and more particularly to uncooled thermal sensors and focal plane arrays.

### BACKGROUND OF THE INVENTION

Thermal sensors detect low level radiation absorbed in a pixel microplatform that is thermally isolated from a substrate. The thermal sensor detects thermal radiance differences between various sources including objects in a scene. In its most common application, arrays of thermal sensors are used in a focal plane as a basic component in a thermal imaging system generally including optics for collecting and focusing the low level radiation from a scene, a detector with an output formatted to displays and database storage, and a mechanical chopper. The chopper produces a constant background radiance which provides a reference signal. The electronic processing portion of the thermal imaging system will subtract the reference signal from the total (biased) radiance signal to produce a signal with minimum background bias.

A radiation sensor based on thermal sensors which generate a change in a signal level due to a change in temperature resulting from incident low level radiation striking a thermally sensitive structure generally includes thermal isolation between the sensitive structure and the associated detector and signal processing circuitry. Without effective thermal isolation the thermal structure will not respond satisfactorily to incident low level radiation. Typically, such thermal structures as part of a radiation sensor, require one or more electrical contacts to conduct a signal to the associated detector in response to incident radiation. These electrical contacts with associated extremely low level electrical signal levels (1) compromise the effectiveness of the thermal isolation between the respective thermally-sensitive structures and the underlying heat sink substrate, (2) provide capacitive and inductive pickup connections which increase the electrical noise of the overall sensor, and (3) require dedicated foundry processing on the same substrate as the integrated circuit detector circuitry.

The hysteric response of a thermister film within a microplatform structure as part of a thermal sensor is the subject of U.S. Pat. No. 6,323,485B1 by Grossman and Reintsema. Here a bolometer based on the sensitivity of an electrical resistance in each pixel is thermally cycled. This invention describes an application for a pyro-electric film functioning as a thermister. The use of a pyro-optical film in an application with a high level photonic carrier beam is not mentioned.

In prior art a mechanical chopper is used to provide a synchronous reference and biased signal which when processed increases the signal to noise level of the detected low level radiation. An example of an advanced electromechanical chopper with an opaque flap structure is described by Carr in U.S. Pat. No. 5,781,331. The present invention does not require the use of a mechanical chopper.

The present invention utilizes a thermally isolated microplatform located above a heat sink substrate. The microplatform is raised a distance above the substrate by supporting structural tether beams. A means of achieving the raised microplatform position without dynamic transient actuation is described by Carr in U.S. Pat. No. 6,091,050.

A notable improvement toward eliminating the electrical signal contacts to the thermally-sensitive microplatform structure in an uncooled thermal sensor is described by Hanson in U.S. Pat. No. 5,512,748. In this patent a pyro-optical film such as barium strontium titanate is mentioned for the purpose of modulating the transmission of a high level photonic carrier beam into a photonic detector.

In U.S. Pat. No. 5,486,698 Hanson describes an uncooled thermal sensor in which the microplatform includes an actuated micromechanical structure which moves to provide a physical thermal conduction path between the microplatform and the heat sink substrate. This actuated thermal conduction link provides a reference signal level for the temperature of the microplatform as it touches the substrate. When the actuated conduction link is not touching the substrate the microplatform is thermally isolated from the substrate and capable of providing a biased signal. In this way a means of mechanical chopping is provided to the uncooled thermal sensor.

The Hanson patent describes a thermal sensor which does not take into account the hysteric response of most pyro-electric films to temperature. In addition the Hanson patent does not describe a means of avoiding the use of actuated, moving, or rotating mechanical structures within or without the thermal sensor for purposes of establishing the reference and biased signal levels. One of the purposes of the present invention is to provide a means of avoiding the use of actuated mechanical structures and instead achieve the equivalent of beam chopping by means of a temperature cycling within each microplatform using localized heating means.

### SUMMARY OF THE INVENTION

The present invention may include a monolithic and optically aligned array of thermal sensors which require no electrical contacts between the the microplatform plane and the detector. The detector may be separated physically from the microplatform plane or the microplatform plane can be created as a self-aligned post process step on the detector plane. The present invention may include a placement of the microplatforms with a high degree of reticulation between adjacent pixel elements to minimize the thermal spreading or thermal cross-talk, thus improving the modulation transfer function of an array of microplatforms.

The basic radiation sensor function is described for one embodiment in the schematic of FIG. 1. Plane 103 containing one or more thermal microplatforms containing a sensitive film of pyro-optical material is shown illuminated by a flood field of light from a high level photonic carrier beam source 102. The thermally sensitive film of pyro-optical material modulates the transmission of the photon carrier beam to the detector plane. The detector plane 105 can be a single discrete detector, but is typically a silicon charge coupled diode CCD or CMOS array of photodetectors. The thermally-sensitive element is the pyro-optical film in the microplatform which will vary the transmission of the photon carrier light through to the detector. The source 102 of the photon carrier beam is typically visible or near infrared obtained from an LED or filtered incandescent lamp which floods the microplatform plane 103 with a more or less uniform, high level intensity. A low level source 101 of radiation is focused by an appropriate lens 104 onto the microplatform plane 103 using appropriate optics or waveguide structures. The microplatform plane 103 is constructed to absorb the low level radiation and thus is heated by said absorption of the low level radiation to a temperature increment higher than the nominal temperature of the microplatform. This differential absorption of the photon carrier beam causes the intensity modulation of the light to the photodetector. This intensity modulation constitutes a biased signal that contains the modulation of the low level radiation. The difference signal from the photodetector 105 representing the amplitude difference between the temperature of the microplatform with and without a modulation due to absorption of the low level radiation is obtained. The difference signal represents an unbiased signal level representative of the actual radiance of the incident low level radiation of interest. In this invention the microplatform is thermally cycled typically with a built-in resistive heater element to successively provide time windows of maximum and minimum sensitivity to the incident low level radiation. The microplatform may also be thermally cycled using a high intensity LED, laser, or filtered incandescent source instead of the LED indicated in FIG. 1.

The radiation sensor of FIG. 1 based on modulation of the transmission of the photonic carrier beam through the pyro-optical film is easily extended to the reflection case. Both the reflectivity and transmission of a photonic carrier beam are modulated by the temperature of the pyro-optical film. The schematic system of FIG. 1 can be revised to describe the case for reflection from the pyro-optical film by repositioning the photodetector array from the right to the left of the MEMS plane in a revision of FIG. 1. In the reflecting case, the photonic carrier beam exiting the MEMS plane is imaged to corresponding pixel locations in the photodetector or photodetector array.

The present invention controls the nominal temperature of pyro-optical film by using microheaters or highly intense illumination to heat the MEMS microplatforms on the MEMS plane 103. The microplatform is thermally cycled around a minor loop of the pyro-optical thin film hysteresis. An example of the hysteresis obtained from a pyro-optical film of vanadium oxide is shown in FIG. 2. Note that the reflectance of the film is relatively temperature invariant as it is heated up to the temperature of 55 deg C. Over

[symbol]

Another important technical and applications advantage is that the design of the MEMS plane can accommodate a wider range of pixels. Microplatform arrays containing matrixes of different pixels sensitive to different spectral windows, for instance VLWIR, LWIR, MIR can be customized in the MEMS plane to provide simultaneous multispectral windows during a single photodetector frame time. When MEMS pixels transparent to the ultraviolet, visible, and near infrared are also included in the MEMS plane, the range of simultaneous imaging with this invention can be termed hyperspectral.

Another technical advantage of the present invention over pyro-electric imagers is that expensive fabrication process steps associated with forming a thermal isolation structure between the focal plane detector array and its associated integrated circuit substrate are greatly reduced. The present invention allows placing the MEMS modulator plane relatively close to the array of photosensors formed on the surface of an integrated circuit substrate. The position of the MEMS plane and the photodetector plane allows for adequate thermal isolation while simultaneously providing self-alignment with respect to each other and substantially minimizing alignment requirements for the photon carrier portion of the associated thermal imaging system.

### BRIEF DESCRIPTION OF THE DRAWINGS

FIG. 1 Schematic drawing showing the major components of an uncooled thermal sensor with low level and high level radiation sources

FIG. 2 Example of a hysteric thermal response loop obtained from a vanadium oxide film

FIG. 3 Representative time base plot of the relevant time domain parameters including the response of pixels responsive to different wavelength windows, pixel heater drive power, and pixel temperature

FIG. 4 Schematic side view of two pixels within an uncooled radiation sensor including the MEMS plane and the detector

FIG. 5 Schematic topview of pixels containing the electrical heaters for thermally cycling the microplatforms to achieve synchronous detection

### DETAILED DESCRIPTION OF THE INVENTION

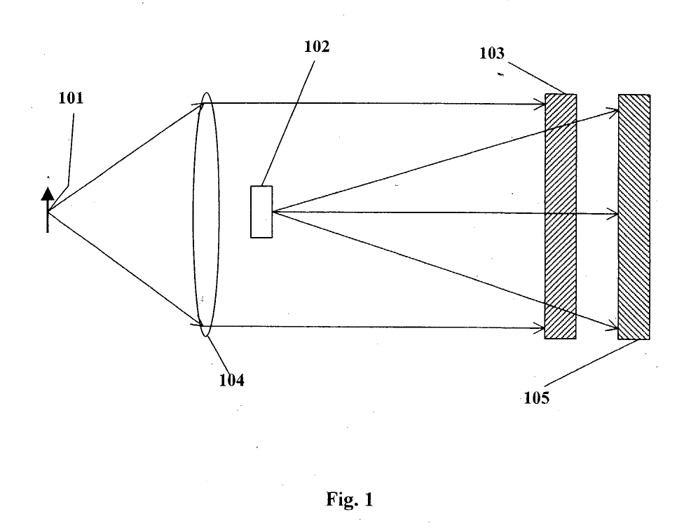

The preferred embodiments of the present invention are understood by referring to FIGS. 1 though 5. FIG. 1 is a block diagram of the thermal imaging system constructed in accordance with the present invention. During operation of the thermal imaging system, infrared radiation from scene is received by collection optics and focused on the photodetector array through the MEMS plane. Signals from the photodetector array which correspond to the incident infrared radiation are delivered to electronics where the signals are processed and passed to displays or database storage systems.

Scene may be any scene of objects that emit a radiation to be detected by the pyro-optical structure in the radiation sensor. The actual radiation to be detected may span the range from the mid infrared to submillimeter wavelengths. The scene source may be located at a distance or it may be very close proximity to the MEMS plane. The minimum useful MEMS pixel footprint size for absorption of radiation over this wavelength range ranges from one half to 2 wavelengths. For instance, a pixel responding to incident submillimeter radiation of 600 GHz, the minimum useful pixel size is around 250 microns. The minimum pixel absorption cross section for absorbing long wavelength infrared LWIR is 16 to 24 microns on a side.

The optics for this range of wavelengths are well known in the art and may be any one of a number of systems of lenses. Optics produce a focused image on the MEMS plane, so that the pyro-optical pixels may sense the radiance of the incident low level radiation it receives. Collection optics may include one or more lenses made of materials or structures that transmit or guide the radiation. Germanium lenses are commonly used in infrared optics.

In the case of scenes of very close proximity to the MEMS plane such as a microculture with chemiluminescence or bioluminescence, may be require focusing optics for imaging to the MEMS plane.

In FIG. 1 the photodetector array may be selected from among a wide variety of available devices. A staring detector may be used which is a large area detector onto which the entire thermal image is focused at once and read out electronically. Among discrete photodetectors useful for this invention are silicon avalanche photodiodes and standard silicon photodiodes. The array photodetectors include the many versions of silicon focal plane arrays including charge coupled diodes CCD, charge injection diodes CID, and addressable diode arrays commonly known as CMOS imagers.

Nonsilicon photonic sensors including indium gallium arsenide may also be used as photodetectors in this invention.

Electronics are used to perform selected operations with the output signals from the photodetector. Functions such as linearity correction, matching to the visual acuity curve, interpolation over dysfunctional pixels, and dynamic ranging are all functions available using current state of the art electronics and algorithmic image processing. Image processing may include analog and digital circuitry.

The photodetector of FIG. 1 may be used with a thermoelectric cooler to improve the signal to noise ratio and dynamic range of the radiation sensor readout.

The photonic carrier source is much higher intensity compared with the low level radiation to be detected. This light source is in the ultraviolet, visible, or near infrared window corresponding to the sensitivity range of the silicon or other semiconductor detector used. The type of light source and the radiation emitted from the light source is selected to be compatible with the photosensors.

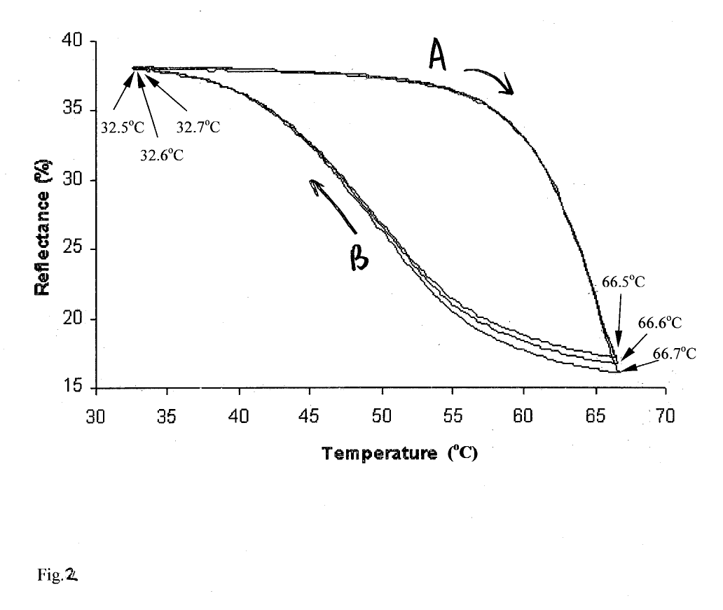

The collection optics and the thermal cycling of the microplatform cooperate with each other to produce two different images on the photodetector array. FIG. 2 shows the frametime A where a reference image is acquired by the photodetector. During frametime B a biased image is acquired including the total radiance of scene 101. Electronics controlling the photodetector frame time-windows will normalize the intensities of frame A and B, then determine the differences between A and B on a pixel by pixel basis, then provide the resulting unbiased image frame representing the radiance image of scene 101.

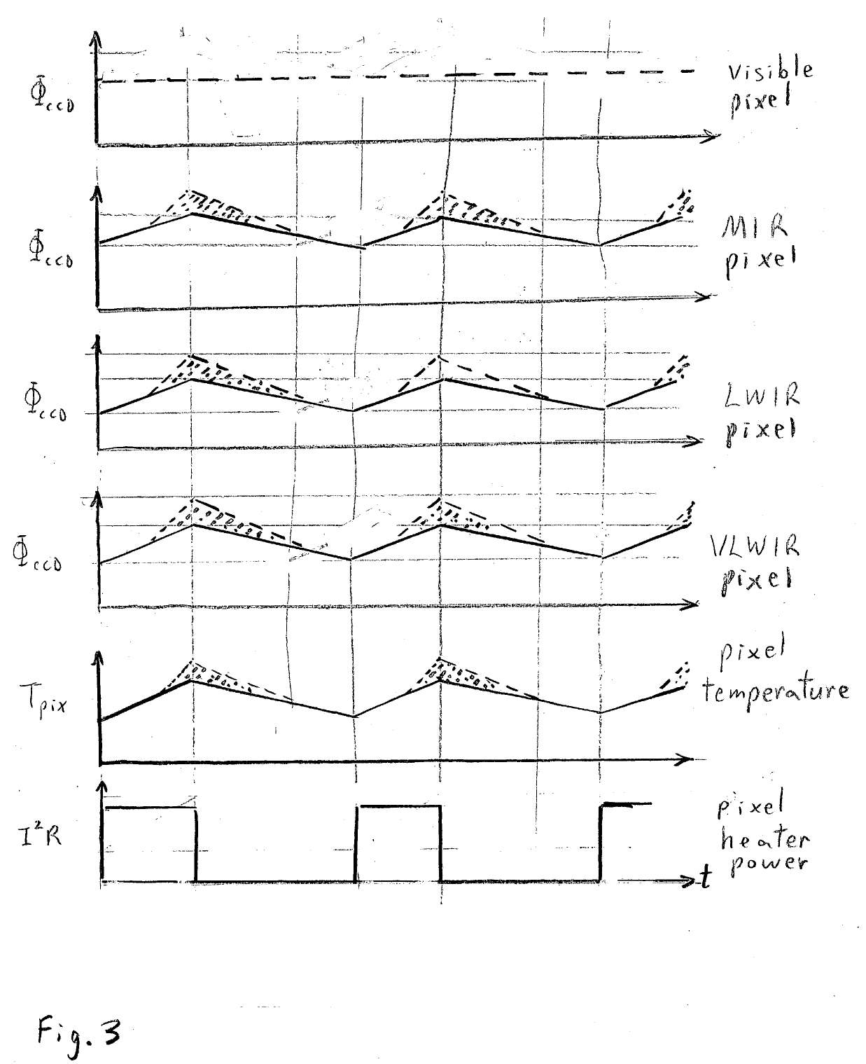

FIG. 3 illustrates the process of establishing a reference signal and a bias signal and repeating this process in a succession of frames to provide a video output. It should be understood that the present invention contemplates either establishing a reference signal before or after detection of a bias signals, or establishing a reference signal before or after a predetermined number of bias signal have been received and processed. In FIG. 3 each pixel is heated for a period of time up to the maximum duration of reference frame A. During this reference frame A the temperature of the microplatform is increasing up to a maximum level. During the bias frame B acquisition each respective MEMS pixel microplatform is cooling from its maximum level at the end of frame A. The scope of this invention is not limited to a radiation sensor containing a MEMS plane sensitive to only a single spectral window.

FIG. 3 illustrates a radiation sensor in which the MEMS plane contains pixels sensitive separately to VLWIR, LWIR, and MIR wavelength windows. Other MEMS plane pixels provide the maximum sensitivity to ultraviolet, visible, and near infrared and are labeled as “visible pixel” in FIG. 3. Those pixels most sensitive to photons from a visible wavelength window do not contain pyro-optical films. For this case in which pixels responsive to different spectral window are placed in the MEMS plane, separate shadow matrices and registration filters are used for spectral filtering.

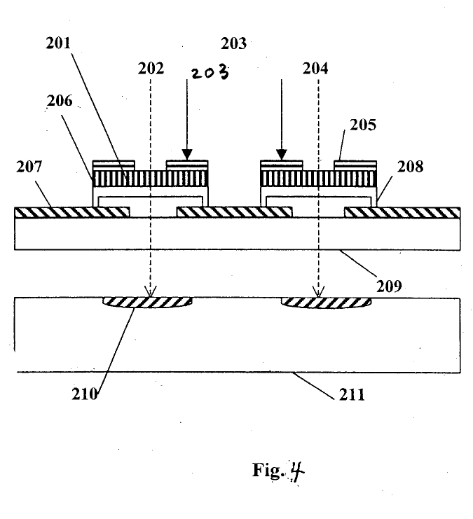

FIG. 4 illustrates an MEMS plane pixel containing the microplatform 208 with the pyro-optical film. This MEMS plane operates to modulate the transmission of the photonic carrier beam 204 terminating in the photodetector 210. This cross section shows incident low level radiation absorbed in the pixel film 205 cooperating with Fabry Perot filtering action between the height of the microplatform 208 and the underlying reflecting film 207. The Fabry Perot etalon structure so defined enhances the pixel sensitivity for incident low level radiation in the wavelength window corresponding to quarter wavelength separations and even multiples thereof.

Films 203, when used, are specific to enhance absorption in the wavelength window for the specific pixel in the MEMS array. For example, films 203 facilitating a broadband absorption of low level radiation in the pixel can include platinum black or a textured metallic film. Films 203 can include both reflection and antireflection structures as necessary to reduce aliasing of higher orders of absorption from the Fabry Perot etalon. The film 201 includes the pyro-optical film serving to modulate the photonic carrier beam 204. The substrates for the MEMS plane 209 and the photodetector plane 211 are in close proximity but not necessarily touching physically.

The MEMS pixel with sensitivity to a submillimeter wavelength window contains an antenna tuned with a matched load structure for providing the desired heating effect from the incident low level submillimeter wave.

The heaters for the individual pixels of the microplatform array are wired to bonding pads in a series and parallel connections using standard photolithographic patterning techniques. These bonding pads are in turn connected to the programmed power supply which causes the temperature of the individual pixels to change through the hysteric cycle.

The top view of a 2×2 MEMS pixel array is shown in FIG. 5 to emphasize the serial connection of the heater within each pixel. The heater 503 is obtained by patterning a thin film resistor of material including for example tantalum silicide, titanium silicide, or polysilicon onto a structure of low thermal conductance such as silicon dioxide. The microplatform 504 is suspended above the MEMS plane substrate by means of low thermal conductivity tether beams 501. The tether beams are anchored to the MEMS substrate by anchors 502. The pyro-optical film 505 is patterned into the supporting microplatform and serves to modulate the photonic carrier beam. The pyro-optical film is generally designed to cover as much of the surface of the microplatform as possible to achieve the maximum index of modulation. The heater is cycled with periods ranging typically from 2 millisec to 100 millisec to acquire the desired combination of frames A and B.

Although the present invention and its advantages have been described in detail, it should be understood that various changes, substitutions and alterations can be made therein without departing from the spirit and scope of the invention as defined by the appended claims.

What is claimed is:

1. A radiation sensor comprising
a microplatform including a pyro-optical film tethered above and thermally isolated from a substrate;
a first source of low level radiation incident upon the microplatform and partially absorbed causing an incremental heating of said film
a second source of high level radiation comprised of a photonic carrier beam incident on said film with reflectivity from or transmission through said microplatform hystereticly modulated by the film temperature
a programmable means of cycling the temperature of the microplatform in a controlled fashion
a detector monitoring the intensity of the photonic carrier beam exiting the microplatform including a means of time-integrating the exiting photonic beam intensity in synchronization with said temperature cycling of the microplatform where the integrated intensity of the photonic carrier beam at said detector is a measure of the intensity of the first source.

2. The radiation sensor of claim 1 where the detector is gated on to integrate the exiting photonic beam during a time window of maximum sensitivity to the first source of low level radiation.

3. The rate sensor of claim 1 where the programmable temperature cycling includes a temperature range where the pyro-optical film is insensitive to said low level radiation source.

4. The radiation sensor of claim 1 where the programmable temperature cycling includes a first temperature range where the pyro-optical film is minimally sensitive to said low level radiation source and a second temperature range where the pyro-optical film shows maximum sensitivity to said low level radiation.

5. The sensor of claim 4 where the detector is:
gated during each temperature cycle to integrate the exiting photonic beam intensity during a first temperature range to define a reference level and separately during a second temperature range to define a biased level;
with a detector readout which obtains a difference signal comparing the biased level and the reference level to create an unbiased level.

6. The radiation sensor of claim 1 where the pyro-optical material is a semiconductor such as vanadium oxide having a hysteretic change between metallic and semiconducting metallurgical phases and where the optical index of refraction changes strongly with temperature in the range of the hysteretic change.

7. The radiation sensor of claim 1 where the pyro-optical film is comprised of a liquid crystal material in which the absorption of the second radiation source increases with increasing temperature.

8. The radiation sensor of claim 1 where the detector is formed separately from said substrate and located in position to receive a modulated high level radiation either reflected from or transmitted through the pyro-optical film.

9. The radiation sensor of claim 1 where the detector is formed within said substrate comprising silicon or other semiconductor material adjacent to the overlying microplatform and positioned to receive the high level radiation exiting the pyro-optical film

10. The radiation sensor of claim 1 where the temperature cycling of the microplatform is provided by thermal heating elements located within the microplatform

11. The radiation sensor of claim where the temperature cycling of the microplatform is provided by either or both heating and cooling elements controlling the temperature of the substrate thereby indirectly controlling the nominal temperature of the microplatform

12. The radiation sensor of claim 1 where said programmable temperature cycling is of higher amplitude than that caused by the combined absorption of said high and low level sources of radiation

13. The sensor of claim 1 where the microplatform contains resistive heating elements that are controlled by an external voltage or current to implement said programmable temperature control.

14. The radiation sensor of claim 1 where the low level radiation incident on and partially absorbed in the microplatform is infrared wavelength radiation

15. The radiation sensor of claim 1 where the low level radiation incident on and partially absorbed in the microplatform is millimeter wavelength radiation

16. The radiation sensor of claim 1 where the low level radiation source is a radiation-emitting chemical reaction or biological process including chemiluminescence and bioluminescence.

17. The radiation sensor of claim 1 where the low level radiation incident on and partially absorbed in the microplatform can be derived from any source capable of heating the pyro-electric film to a temperature in excess of the system minimum detectable signal level.

18. The radiation sensor of claim 1 where the second radiation source is an ultraviolet, visible, or near infrared light source comprised of a light emitting diode, incandescent source, or a laser source matched in spectral range to that of the detector.

19. The sensor of claim XX where the detector is a photonic sensor including silicon, gallium arsenide, indium gallium arsenide, gallium nitride, and indium arsenide.

20. The radiation sensor of claim 1 where the low level and high level sources of radiation may be derived from more than two sources.

21. The radiation sensor of claim 1 where the programmable temperature cycling is obtained by absorption of a third source of high intensity radiation such as a laser or a spectrally-filtered high intensity incandescent source in a wavelength range where the detector is insensitive.

22. The radiation sensor of claim 1 where the detector is formed within said substrate comprising silicon or other semiconductor material adjacent to the overlying microplatform and positioned to receive the high level radiation exiting the pyro-optical film.

23. The radiation sensor of claim 1 configured as an array of pixels and aligned to a detector comprised of a charge-coupled diode CCD or CMOS imager array with signal conditioning circuitry providing an output signal for driving external image displays or formatted for external databases.

24. The radiation sensor of claim 1 with the low level radiation imaged onto the plane of an array of microplatforms and with the detector consisting of a charge-coupled diode CCD or CMOS imaging plane to further comprise an imaging radiation sensor

25. The radiation sensor of claim 1 with the microplatform operated in a vacuum or encapsulated by a low thermal conductivity material for the purpose of increasing thermal isolation of the microplatform from said substrate.

26. A method for producing an image of a scene using a thermal imaging system having a plurality of thermal sensors with elements sensitive to low level radiation mounted on or adjacent to an integrated circuit substrate comprising means of:
thermally isolating the sensitive element within each thermal sensor from the integrated circuit substrate to form an image representative of the low level radiation
temperature cycling the thermal sensor microplatform through regions of maximum and minimum sensitivity to the low level radiation to establish a reference and simultaneously maintaining a condition of thermal isolation of the microplatform from the substrate
directing incident low level radiation from the scene onto the infrared sensitive elements of the sensors sensitive to said low level radiation to form a thermal image
projecting a high level radiation from a light source onto the thermal sensors and exiting to the adjacent surface of the integrated circuit
detecting the low level radiation with an array of photosensors contained within said integrated circuit to form a signal representative of the image formed on the element sensitive to the respective thermal sensor
